(19) United States
(12) Patent Application Publication
(10) Pub. No.: US 2013/0260224 A1
(43) Pub. Date: Oct. 3, 2013

(54) OXYGEN SHUTTLE BATTERY

(71) Applicant: THE UNIVERSITY OF TOKYO, Tokyo (JP)

(72) Inventors: Mitsuhiro HIBINO, Kyoto (JP); Noritaka MIZUNO, Tokyo (JP); Tetsuichi KUDO, Tokyo (JP); Yosuke SUGA, Tokyo (JP); Takeshi KIMURA, Tokyo (JP)

(73) Assignee: THE UNIVERSITY OF TOKYO, Tokyo (JP)

(21) Appl. No.: 13/650,742

(22) Filed: Oct. 12, 2012

(30) Foreign Application Priority Data
Apr. 3, 2012 (JP) 2012-084576

(51) Int. Cl. H01M 4/52; H01M 10/36

(52) U.S. Cl. CPC H01M 4/52; H01M 10/36; H01M 4/521; H01M 4/523
USPC 429/188; 429/209; 429/218.1; 429/221; 429/211

(57) ABSTRACT

The present invention provides a new rocking-chair-type battery employing oxygen ions as a charge shuttle that can be used to replace lithium ion batteries. The battery of the present invention is an oxygen shuttle battery comprising two electrodes that are comprised of a compound capable of oxygen intercalation at least in part and an electrolyte permeable to oxygen atoms that is present between the two electrodes. The compound capable of oxygen intercalation is, for example, at least one compound selected from the compound denoted by the general formula AMO_{z}, where A denotes 1 or 2 or more monovalent elements, divalent elements, or trivalent elements, and M denotes 1 or 2 or more monovalent elements, divalent elements, or trivalent elements, with 2.0<Z≦3.0.

### CROSS-REFERENCE TO RELATED PATENT APPLICATIONS

The present application claims priority under Japanese Patent Application 2012-84576, filed on Apr. 3, 2012, the entire contents of which are hereby incorporated by reference.

### TECHNICAL FIELD

The present invention relates to an oxygen shuttle battery, and more particularly, to a rocking-chair-type oxygen ion battery in which oxygen ions or oxygen-containing ions move between electrodes in the course of charging and discharging.

### BACKGROUND ART

Lithium ion batteries are widely employed as secondary batteries permitting size and weight reduction. However, the locations of lithium resources are unevenly distributed. From the perspective of ensuring resources, the development of a substitute resource or a substitute technology is necessary from the viewpoint of guaranteeing future security. However, the reality is that there does not seem to be any element that can be substituted for lithium, which has an atomic weight of about 7 and functions as a charge shuttle in the form of lithium ions, in lithium ion batteries.

### DISCLOSURE OF THE INVENTION

Accordingly, the object of the present invention is to provide a new rocking-chair-type ion battery that can be used to replace lithium ion batteries.

To solve the above problem, the present inventors conducted various research studies. As a result, they discovered that by using compounds capable of oxygen intercalation, it was possible to construct a rocking-chair-type battery of oxygen ions. The present invention was devised on that basis.

Japanese Unexamined Patent Publication (KOKAI) No. 2005-190833 (Patent Reference 1 hereinafter) discloses an air electrode for a secondary battery comprised of a Perovskite-type oxide and carbon powder. However, since this electrode is for use in metal air batteries:

i. the reduction of oxygen molecules is used as a discharge reaction, and a reaction in which hydroxide ions are oxidized to generate oxygen is employed as a charge reaction;
ii. a reaction that changes the oxygen composition of an oxide is not employed as a battery reaction.

In contrast, the present invention:

i. uses a reaction in which the oxide ions in hydroxide ions are moved in and out of an oxide in charging and discharging, with this being done in a region that does not generate oxygen, thereby clearly differentiating it from the method employed in Patent Reference 1, which employs an oxygen-generating reaction; and
ii. differs in that the oxygen composition of the oxide constituting the electrodes changes in the electrode reaction.

For the above reasons, the present invention is clearly different from the invention described in Patent Reference 1.

The present invention provides a completely new rocking-chair-type battery employing oxygen ions as a charge shuttle.

### BRIEF DESCRIPTION OF THE DRAWINGS

FIG. 1 shows the measurement system employed in testing electrochemical characteristics.

FIG. 2 shows the reduction or oxidation profile at a certain current (C/50) in the Ca_{0.5}La_{0.5}FeO₂ (Z=2.863) obtained in Embodiment 1.

FIG. 3 shows the transition in the position of the XRD diffraction peak accompanying the electrochemical reduction of the Ca_{0.5}La_{0.5}FeO₂ (Z=2.863) obtained in Embodiment 1.

FIG. 4 shows the electrochemical reduction and oxidation profile when cycled in the vicinity of 0 V (−0.5 to 0.5 V) or in the vicinity of −0.75 V (−1.1 to −0.4 V) achieved in Embodiment 1.

FIG. 5 shows the electrochemical reduction profile obtained in Embodiment 2.

FIG. 6 shows the XRD profile before and after electrochemical oxidation obtained in Embodiment 2.

FIG. 7 shows the electrochemical oxidation and reduction profile obtained in Embodiment 3.

FIG. 8 shows the XRD profile before and after electrochemical oxidation obtained in Embodiment 3.

FIG. 9 shows the electrochemical oxidation profile obtained in Embodiment 4.

FIG. 10 shows the XRD profile before and after electrochemical oxidation obtained in Embodiment 4.

### MODES OF CARRYING OUT THE INVENTION

Compounds capable of oxygen intercalation (referred to as “OIC compounds” hereinafter) are compounds that can be reversibly oxidized and reduced, with the oxidation and reduction being accompanied by the release and acceptance of oxygen. The use of a compound that can be reversibly oxidized and reduced as an electrode in a battery that can be repeatedly charged and discharged requires that the compound be structurally stable in the electrochemical oxidation and reduction accompanying the release and acceptance of oxygen ions, that is, in the removal and insertion of oxygen ions. From such a perspective, examples of OIC compounds are compounds with perovskite-type structures; compounds with brownmillerite-type structures, consisting of compounds with perovskite-type structures from which oxygen has been systematically removed; and compounds with infinite layer structures, consisting of compounds with brownmillerite-type structures from which oxygen has been systematically removed.

For example, OIC compounds can be denoted by the general formula AMO_{z}, where A denotes 1 or 2 or more monovalent elements, divalent elements, or trivalent elements, and M denotes 1 or 2 or more elements that can assume valences of 1 to 4, with 2.0<Z≦3.0.

When Z is 3.0, a perovskite-type structure is indicated. When Z is less than 3.0, the closer Z approaches 3.0, the greater the similarity to a Perovskite structure and the closer Z approaches 2, the greater the similarity to an infinite layer structure. From the perspective of ease of synthesis, 2.5≦Z≦3.0 is desirable. However, from the perspective of providing a battery with a broad range of characteristics, an OIC compound with a range of 2.0<Z≦2.5 is desirable.

Examples of the element denoted by A are alkali metal elements (such as Li, Na, K, Rb, and Cs), alkaline earth metal elements (such as Mg, Ca, Sr, and Ba), rare earth elements (such as Sc and Y, and lanthanide elements (such as La, Ce, Pr, Nd, Pm, Sm, Eu, Gd, Tb, Dy, Ho, Er, Tm, Yb, and Lu)).

Examples of the element denoted by M are late transition metal elements. Of these, elements of group VIII (such as iron, cobalt, and nickel) and copper are examples.

Specific examples of OIC compounds are given below:

Ca_{0.5}La_{0.5}FeO_{z} Z=2.25 to 3.0

Sr_{0.5}La_{0.5}FeO_{z} Z=2.25 to 3.0

BaFeO_{z} Z=2.5 to 3.0

LaNiO_{z} Z=2.0 to 3.0

SrFeO_{z} Z=2.5 to 3.0

Sr₁₋ₓCaₓFeO_{z} 0<X 1.0 Z=2.0 to 3.0

SrCoO_{z} Z=2.5 to 3.0

LaCuO_{z} Z=4.0 to 4.5

LaNiO_{z} Z=4.0 to 4.5

The above OIC compounds can be produced, for example, by the existing solid state synthesis method and citric acid method.

Ca_{0.5}La_{0.5}FeO_{z} (Z=2.25 to 3.0)

Sr_{0.5}La_{0.5}FeO_{z} (Z=2.25 to 3.0)

BaFeO_{z} (Z=2.5 to 3.0)

LaNiO_{z} (Z=2.0 to 3.0)

Synthesis methods are also given for the above compounds in the embodiments.

LaNiO_{z} (Z=2.0 to 3.0) can also be synthesized by the methods described in (A): J. A. Alonso, et al., J. Phys.: Condens. Matter, 9, 6417, 1997; (B): M. Crespin et al., J. Chem. Soc. Faraday Trans. II, 79, 1181, 1983; P. Levitz, et al., J. Chem. Soc. Faraday Trans. II, 79 1195, 1983; and (C): M. Kawai, et al., App. Phys. Lett., 94, 082102, 2009, for example.

SrFeO_{z} (Z=2.5 to 3.0) can be synthesized by the methods described in (D): A. Wattiaux, et al., Solid State Comm., 77, 489, 1991, and (E): Y. Takeda, et al., J. Ceram. Soc. Jpn., 106, 759, 1998; A. Nemudry, et al., Chem. Mater., 10, 2403, 1998, for example.

Sr₁₋ₓCaₓFeO_{z} 0<X<1.0 Z=2.0 to 3.0 can be synthesized by the methods described in (F): Y. Tsujimoto, et al., Nature, 450, 1062, 2007, and Y. Shimakawa et al., Cryst. Growth Des., 10, 4713, 2010, for example.

SrCoO_{z} (Z=2.5 to 3.0) can be synthesized by the method described in (G): R. Toquin, et al., J. Am. Chem. Soc., 128, 13161, 2006, for example.

LaCuO_{z} (Z=4.0 to 4.5) can be synthesized by the method described in (H): F. Arrouy, et al., Phys. Rev. B54, 7512, 1996, for example.

LaNiO_{z} (Z=4.0 to 4.5) can be synthesized by the method described in (I): J.-C. Grenier, et al., J. Solid State Chem., 96, 20, 1992, for example.

The references denoted by (A) to (I) above are hereby specifically incorporated in their entirety by reference.

In the oxygen shuttle battery of the present invention, two electrodes comprised of an OIC compound at least in part are employed. The two electrodes comprised of an OIC compound at least in part can be fabricated, for example, by drying a material as needed and then pressing just the OIC compound. Alternatively, in addition to an OIC compound, a mixture of a conductive agent and/or a binder can be pressed to fabricate the electrodes. Examples of conductive agents that can be employed are carbonaceous materials, metals, semiconductors, metal carbides, and metal compounds. Examples of carbonaceous materials are artificial graphite, natural graphite, acetylene black, and carbon black. Examples of metals are tin, gallium and aluminum. An example of a semiconductor is silicon. Examples of metal carbides are electrically conductive titanium carbide, tantalum carbide, tungsten carbide, and zirconium carbide. Examples of binders that can be employed are polyvinylidene fluoride (PVdF), polytetrafluoroethylene (PTFE), styrenebutylene rubber (SBR), and polyacrylic nitrile (PAN).

The compounds constituting the electrodes are selected so that one of the two electrodes in the oxygen shuttle battery of the present invention is positive and the other is negative.

The compound constituting the positive electrode and the compound constituting the negative electrode can be of the same series, that is, can be compounds differing only in the quantity of oxygen, with the other elements being identical, or can be compounds differing in terms of elements other than oxygen.

An example of a case in which the two compounds employed differ in terms of the quantity of oxygen but are identical in terms of other elements will be described. In the case of the OIC compound Ca_{0.5}La_{0.5}FeO_{z} (Z=2.6 to 2.9), for example, one of the electrodes is comprised of Ca_{0.5}La_{0.5}FeO_{z} (Z=2.9) and the other electrode is comprised of Ca_{0.5}La_{0.5}FeO_{z} (Z=2.6). When these electrodes are brought into contact with an oxygen-ion-permeable electrolyte, the electrode comprised of Ca_{0.5}La_{0.5}FeO_{z} (Z=2.9) becomes positive and the electrode comprised of Ca_{0.5}La_{0.5}FeO_{z} (Z=2.6) becomes negative.

When the battery discharges, oxygen ions (O²⁻) are released by the positive electrode, and the Z of the Ca_{0.5}La_{0.5}FeO_{z} (Z=2.9) decreases from 2.9. The negative electrode picks up oxygen ions (O²⁻), and the Z of the Ca_{0.5}La_{0.5}FeO_{z} (Z=2.6) increases from 2.6.

For example, when the discharge is stopped when the Z of the Ca_{0.5}La_{0.5}FeO_{z} of the positive electrode has dropped to 2.8 and the Z of the Ca_{0.5}La_{0.5}FeO_{z} has increased to 2.7, and exterior charging is conducted, oxygen ions (O²⁻) are inserted in the Ca_{0.5}La_{0.5}FeO_{z} of the positive electrode and Z increases from 2.8 toward 2.9, and oxygen ions (O²⁻) are extracted from the Ca_{0.5}La_{0.5}FeO_{z} of the negative electrode, with Z dropping from 2.7 toward 2.6.

The above discharge reaction [M₁O_{Z1}|NaOH|M₂O_{Z2}] is given below denoting the positive electrode material as M₁O_{Z1}, the negative electrode material as M₂O_{Z2}, and using an electrolyte in the form of NaOH. The oxygen ions (O²⁻) extracted from the positive electrode become OH⁻ in the aqueous electrolytic solution, migrating into the electrolytic solution. At the negative electrode, oxygen ions (O²⁻) are inserted in the electrode from OH⁻.

Positive electrode reaction: M₂O_{Z2}+(½)H₂O+xe⁻->M₂O_{Z2-x/2}+xOH⁻
Negative electrode reaction: M₁O_{Z1}+xOH⁻->M₁O_{Z1+x/2}+(½)H₂O+xe⁻
Overall reaction: M₁O_{Z1}+M₂O_{Z2}->M₁O_{Z1+x/2}+M₂O_{Z2-x/2}

The electrolyte that is permeable to oxygen atoms that is present between the two electrodes can be solvent-system or can be a solid electrolyte. Examples of solvent-system electrolytes are non-aqueous and aqueous electrolytes. The oxygen-ion-permeable electrolyte is desirably non-aqueous. An example of a non-aqueous electrolyte is oxygen acid ions. Examples of oxygen acid ions are borate ions (BO₃³⁻) and phosphate ions (PO₄³⁻). The migration of oxygen ions based on borate ions (BO₃³⁻) and phosphate ions (PO₄³⁻) can occur in accordance with the following expressions:

### 4BO₃³⁻<=>B₄O₇²⁻+5O²⁻

### 2PO₄³⁻<=>P₂O₇⁴⁻+O²⁻

Examples of solvents that can be employed in non-aqueous electrolytes are cyclic carbonic acid esters, linear carbonic acid esters, esters, cyclic ethers, linear ethers, nitriles, and amides. Examples of cyclic carbonic acid esters are ethylene carbonate, propylene carbonate, and butylene carbonate. Such compounds in which part or all of the hydrogen has been fluorinated can be employed. Examples are trifluoropropylene carbonate and fluoroethylene carbonate. Examples of linear carbonic acid esters are dimethyl carbonate, ethyl methyl carbonate, diethyl carbonate, methyl propyl carbonate, ethyl propyl carbonate, and methyl isopropyl carbonate. Such compounds in which part or all of the hydrogen has been fluorinated can be employed. Examples of esters are methyl acetate, ethyl acetate, propyl acetate, methyl propionate, ethyl propionate, and γ-butyrolactone. Examples of cyclic ethers are 1,3-dioxolane, 4-methyl-1,3-dioxolane, tetrahydrofuran, 2-methyltetrahydrofuran, propyleneoxide, 1,2-butyleneoxide, 1,4-dioxane, 1,3,5-trioxane, furan, 2-methylfuran, 1,8-cineole, and crown ether. Examples of linear ethers are 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethyleneglycol dimethyl ether, diethyleneglycol diethyl ether, diethyleneglycol dibutyl ether, 1,2-dimethoxymethane, 1,2-diethoxyethane, triethyleneglycol dimethyl ether, and tetraethyleneglycol dimethyl. An example of a nitrile is acetonitrile. An example of an amide is dimethylformamide. At least one selected from among the above can be employed.

Examples of aqueous electrolytes are alkali compounds such as alkali metal hydroxides (such as potassium hydroxide, sodium hydroxide, and lithium hydroxide). An expression showing the migration of oxygen ions in a hydroxide is given below:

### 4OH⁻<=>2H₂O⁻+2O²⁻

Examples of solid electrolytes are yttria-stabilized zirconia (YSZ) and LaGaO₃.

The oxygen shuttle battery of the present invention can contain a separator or the like in addition to the two electrodes and electrolyte. In addition to the two electrodes and electrolyte, the oxygen shuttle battery of the present invention can comprise structural battery members such as a separator, a battery case, and a collector that supports the electrodes and collects electricity. Structural battery components such as a separator are not specifically limited; various known members can be selectively employed.

### EXAMPLES

The present invention will be described more specifically below through examples. However, there is no intent to limit the present invention to the examples.

### Reference Examples (Preparation of Electrode Materials)

### (1) Sr_{0.5}La_{0.5}FeO_{z} and Ca_{0.5}La_{0.5}FeO_{z}

Fe(NO₃)₃.9H₂O and La(CH₃COO)₃.1.5H₂O, Ca(CH₃COO)₂.H₂O, or Sr(CH₃COO)₂.O..5H₂O were dissolved along with citric acid in extra pure water. Citric acid was added to twice the concentration of the various metallic ions. Employing a rotary evaporator, drying and solidification were conducted at 60° C., followed by vacuum drying (100° C., 1 hour). Comminution was conducted in an agate mortar, after which the product was charged to a crucible, heat treated in air at 300° C. for 6 hours, and allowed to cool naturally. The product was then sintered at 1,000° C. for 10 minutes and allowed to cool naturally in the oven to room temperature. Powder X-ray diffraction (XRD) confirmed the presence of a single phase. An Sr_{0.5}La_{0.5}FeO_{z} compound in which Z was 2.929 and a Ca_{0.5}La_{0.5}FeO_{z} compound in which Z was 2.863 were synthesized.

### (2) BaFeO_{2.5}

Following comminution and mixing of barium carbonate and α-iron (III) oxide, the mixture was heat treated in air at 1,000° C. for 5 hours and allowed to cool naturally. It was then comminuted in an agate mortar and pressed into pellets. The pellets were heat treated in a nitrogen atmosphere at 1,200° C. and then rapidly cooled with liquid nitrogen. Powder X-ray diffraction (XRD) confirmed a single phase.

### (3) LaNiO₃

Ni(CH₃COO)₂.4H₂O and La(CH₃COO)₃.1.5H₂O were dissolved in extra pure water and then solidified and dried using a rotary evaporator at 85° C. Following comminution in an agate mortar, the mixture was charged to a crucible, heat treated in air at 300° C. for 1 hour, and thenat 650° C. for 1 hour, and allowed to cool naturally. The product was then mixed with an equal weight of sodium carbonate, charged to a crucible made of nickel, and heat treated at 900° C. for 30 hours followed by at 600° C. for 6 hours. Subsequently, the product was repeatedly cleaned with distilled water to remove the sodium carbonate. Powder X-ray diffraction (XRD) confirmed a single phase.

### Test Methods

### (1) Electrode Fabrication

OIC samples synthesized in the above Reference Examples were thoroughly comminuted in an agate mortar and then kneaded with conductive additives such as graphite and binder materials such as PTFE powder. The typical blending ratio is OIC sample:carbon-based conductive additive:PTFE=90:8:2 (w/w). The kneaded mixture was pressed at about 200 MPa for 1 minute to be a form with a thickness of about 0.3 mm on gold mesh, platinum mesh, and the like.

### (2) Electrochemical Characteristic Testing

The electrochemical characteristics (oxidation and reduction characteristics) of the electrodes fabricated above were tested by the following methods.

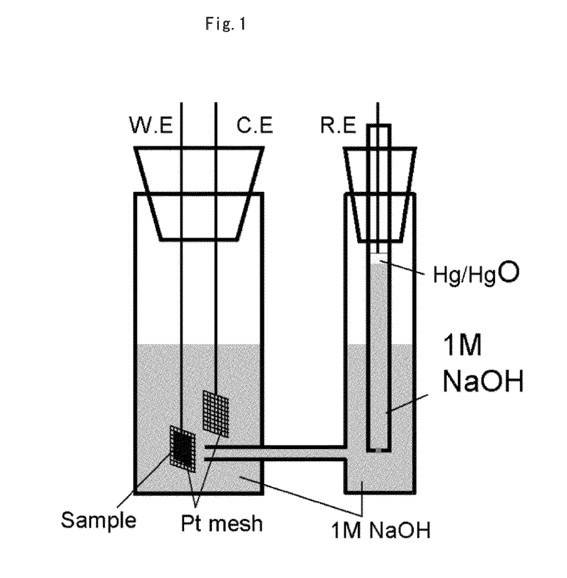

See FIG. 1 for the test system.
Working electrode: A mixture of OIC sample, graphite, and PTFE pressure bonded to gold or platinum
Counter electrode: Pt mesh
Reference electrode: Hg/HgO, NaOH (1M), (0.10 V vs. SHE (25° C.))
Electrolytic solution: 1 M NaOH

### Measurement Mode

Constant current mode: C/100, C/50, C/25 (current density 1C: a current density at which the change in composition from AMO 2.5 to AMO 3 (or AMO 2.5 to AMO 2) progressed for 1 hour)
Measurement of open circuit potential: the potential was recorded as the open circuit potential at which the fluctuation in potential in an open circuit became less than 1 mV/h after conducting oxidation or reduction at a constant current in the OIC sample.

### (3) XRD Measurement

Structural change of the compound produced in conjunction with the electrochemical reaction was measured by XRD.

### Example 1

### Ca_{0.5}La_{0.5}FeO_{2.863}

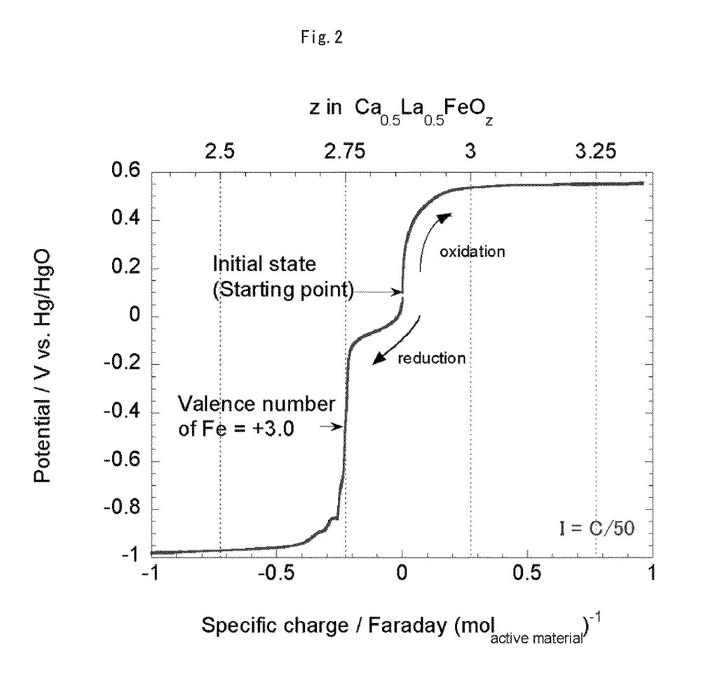

FIG. 2 shows the results of electrochemical characteristic testing.

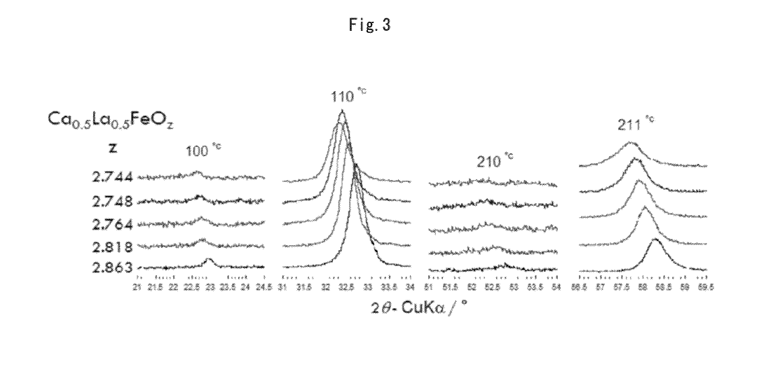

FIG. 3 shows the results of structural change measured by XRD.

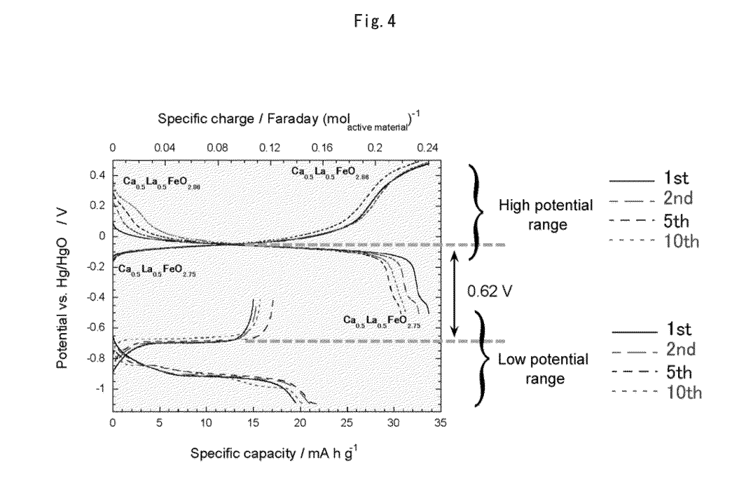

Employing Ca_{0.5}La_{0.5}FeO_{2.863} as the electrode material, the oxidation and reduction cycle was measured for potential range settings. The method was identical to that used to measure electrochemical characteristics above. The results are given in FIG. 4.

### Example 2

### LaNiO₃

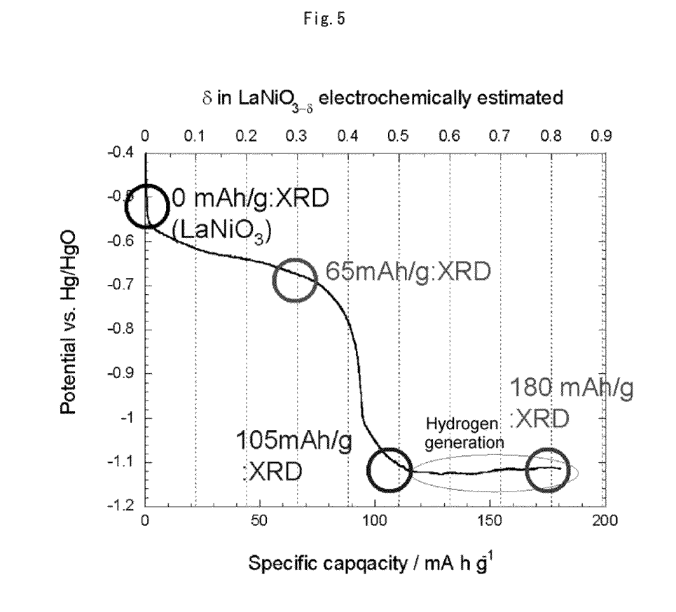

FIG. 5 shows the results of electrochemical characteristic testing.

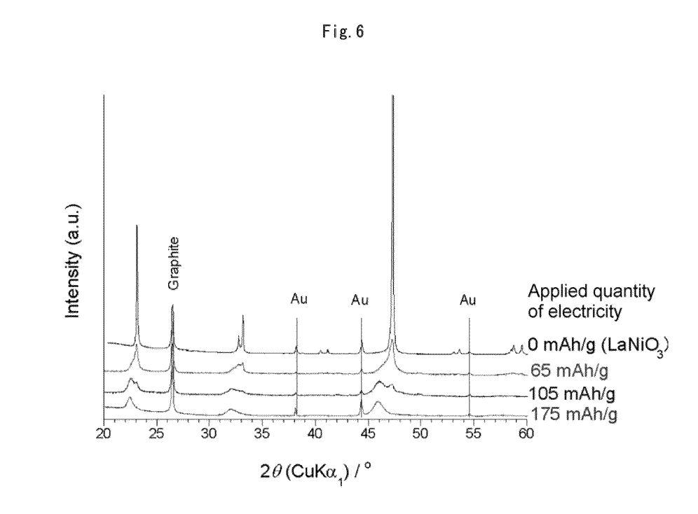

FIG. 6 shows the results of structural change measured by XRD.

### Example 3

### Sr_{0.5}La_{0.5}FeO_{2.929}

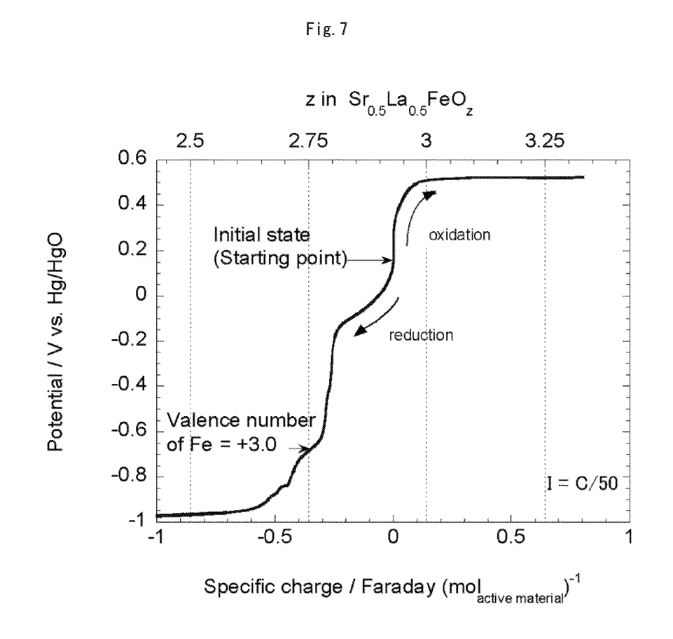

FIG. 7 shows the results of electrochemical characteristic testing.

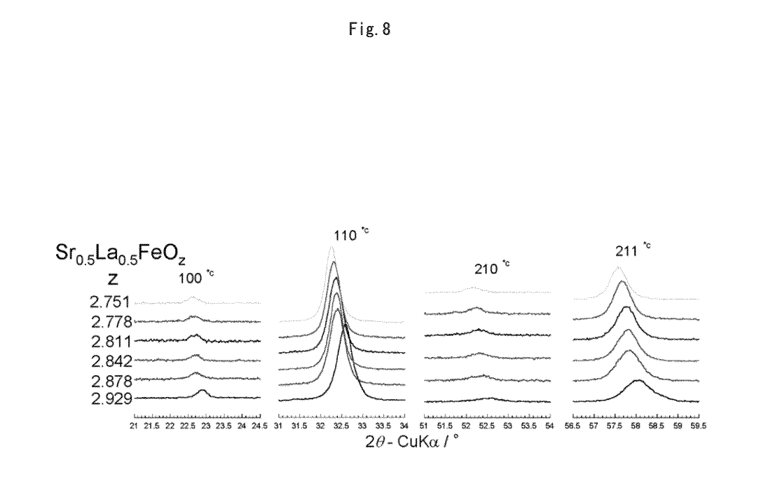

FIG. 8 shows the results of structural change measured by XRD.

### Example 4

### BaFeO_{2.5}

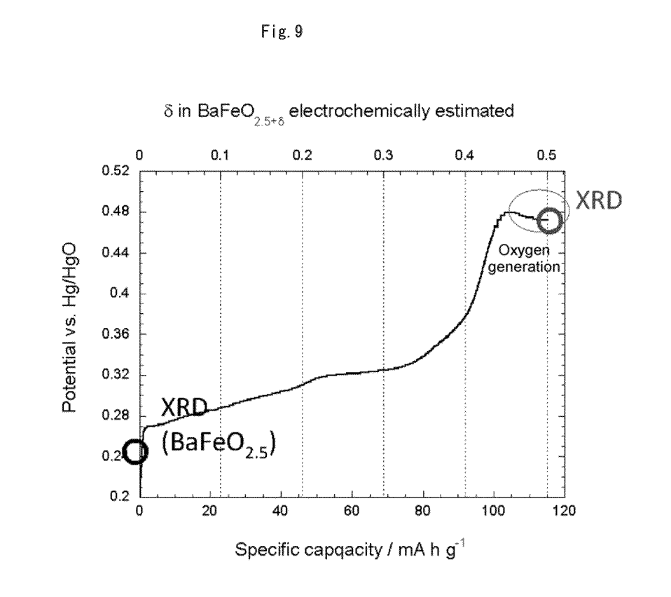

FIG. 9 shows the results of electrochemical characteristic testing.

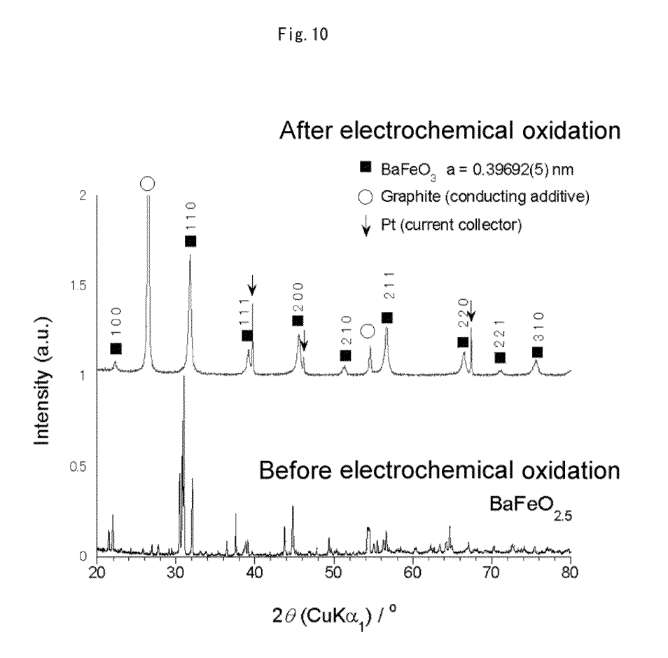

FIG. 10 shows the results of structural change measured by XRD.

### INDUSTRIAL APPLICABILITY

The present invention is useful in the technical field of batteries.

What is claimed is:

1. An oxygen shuttle battery comprising two electrodes that are comprised of a compound capable of oxygen intercalation at least in part and an electrolyte permeable to oxygen atoms that is present between the two electrodes.

2. The oxygen shuttle battery according to claim 1, wherein the compound capable of oxygen intercalation is at least one compound selected from the compound denoted by the general formula AMO_{z}, where A denotes 1 or 2 or more monovalent elements, divalent elements, or trivalent elements, and M denotes 1 or 2 or more monovalent elements, divalent elements, or trivalent elements, or tetravalent elements, with 2.0<Z≦3.0.

3. The oxygen shuttle battery according to claim 1, wherein the compound capable of oxygen intercalation is at least one compound selected from the group of the compounds below:
Ca_{0.5}La_{0.5}FeO_{z} Z=2.25 to 3.0
Sr_{0.5}La_{0.5}FeO_{z} Z=2.25 to 3.0
BaFeO_{z} Z=2.5 to 3.0
LaNiO_{z} Z=2.0 to 3.0
SrFeO_{z} Z=2.5 to 3.0
Sr₁₋ₓCaₓFeO_{z} 0<X 1.0 Z=2.0 to 3.0
SrCoO_{z} Z=2.5 to 3.0
LaCuO_{z} Z=4.0 to 4.5
LaNiO_{z} Z=4.0 to 4.5

4. The oxygen shuttle battery according to claim 1, wherein the electrolyte permeable to oxygen atoms is a solvent-system compound.

5. The oxygen shuttle battery according to claim 1, wherein the solvent-system is non-aqueous-system or aqueous-system.

6. The oxygen shuttle battery according to claim 1, wherein the electrolyte permeable to oxygen atoms is a solid electrolyte.

7. The oxygen shuttle battery according to claim 1, further comprises at least a separator, a battery, and a current collector.
